(19) United States
(12) Patent Application Publication
(10) Pub. No.: US 2024/0149823 A1
(43) Pub. Date: May 9, 2024

(54) DRIVER AIRBAG COVER

(71) Applicant: Divergent Technologies, Inc, Los Angeles, CA (US)

(72) Inventors: Jon Christopher CHARLAND, Long Beach, CA (US); Cheng Wei YU, Pasadena, CA (US); Kamesh Arusuthipattu DURAISINGAM, Royal Oak, MI (US)

(21) Appl. No.: 18/501,838

(22) Filed: Nov. 3, 2023

Related U.S. Application Data
(60) Provisional application No. 63/422,189, filed on Nov. 3, 2022.

(51) Int. Cl. B60R 21/2165

(52) U.S. Cl. CPC B60R 21/21656

(57) ABSTRACT

A vehicle airbag cover includes a cover member configured to house an airbag and an airbag housing member or a portion of an airbag and airbag housing member fitted within a steering wheel of a car. The vehicle airbag cover further includes a plurality of perforations on the cover member, wherein the perforations define a tear seam and are configured to allow the cover member to tear open upon deployment of the airbag.

### CROSS REFERENCE TO RELATED APPLICATIONS

This application claims priority to U.S. Provisional Application No. 63/422,189 titled “DRIVER AIRBAG COVER” filed Nov. 3, 2022, which is assigned to the assignee hereof, and incorporated by reference in its entirety as if fully set forth herein.

### TECHNICAL FIELD

The present disclosure generally relates to a cover apparatus for covering an airbag, such as an airbag cover located within a steering wheel of a car.

### BACKGROUND

Driver and passenger safety in vehicles is a critical element in the design of vehicles, specifically with regard to airbags. Most vehicles use a hard plastic break-away cover, usually in black, to cover airbags, most notably steering wheel airbags. The hard plastic cover may have an undesirable look and feel, particularly on high-end luxury cars. However, no alternative solutions have been offered because the safety-critical nature of this part demands predictable break-away properties so the airbag can deploy safely without fail. Therefore, improvements in vehicle airbag covers are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to one example, a vehicle airbag cover includes: a cover member configured to house an airbag and an airbag housing member, or a portion of the airbag and the airbag housing member, fitted within a steering wheel of a car; and a plurality of perforations on the cover member, which comprise a tear seam, and that are configured to allow the cover member to tear open upon deployment of the airbag.

Another example aspect includes a vehicle airbag cover wherein a cover material of the cover member comprises polyester and polyurethane.

Another example aspect includes a vehicle airbag cover wherein a cover material of the cover member comprises leather, cloth, fabric, or foam rubber.

Another example aspect includes vehicle airbag cover wherein the plurality of perforations partially penetrate through the cover member.

Another example aspect includes a vehicle airbag wherein the plurality of perforations completely penetrate through the cover member.

Another example aspect includes a vehicle airbag cover wherein the plurality of perforations are arranged in a pattern that allows for the airbag cover to tear in a controlled manner.

Another example aspect includes a vehicle airbag cover wherein the pattern of the plurality of perforations include a periodic wave pattern.

Another example aspect includes a vehicle airbag cover wherein the periodic wave pattern comprises at least one of a sinusoidal wave, a saw-tooth wave, a triangle wave, or a square wave.

Another example aspect includes a vehicle airbag cover wherein the pattern of the plurality of perforations has a variable width.

Another example aspect includes a vehicle airbag cover wherein the variable width is configured to allow the airbag cover to tear if at least a portion of the plurality of perforations are spaced apart from a tear seam pattern of the airbag housing member.

Another example aspect includes a vehicle airbag cover wherein the plurality of perforations are arranged in a pattern that repeatedly crosses a tear seam pattern of the airbag housing member.

Another example aspect includes a vehicle airbag cover wherein a plurality of perforations are arranged in a plurality of patterns which each cross over one another and that each repeatedly cross over a tear seam pattern of the airbag housing member.

Another example aspect includes a vehicle airbag cover wherein each of the plurality of perforations comprise dots or line segments.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a front view of an exemplary vehicle airbag cover including at least one cover member tear seam (indicated by dashed lines) aligned with at least one airbag housing member tear seam (indicated with a solid line, for clarity, even though in operation this would be not visible as it is located underneath the airbag cover).

FIG. 2 is a front view of the vehicle airbag cover of FIG. 1 with the airbag cover in a torn open state, exposing an airbag housing member and corresponding airbag housing member tear seams.

FIGS. 3A-3H are example patterns of perforations.

FIG. 4 is an example of different perforation widths and depths.

### DETAILED DESCRIPTION

Various aspects of the disclosure are now described with reference to the drawings, wherein like reference numerals are used to refer to elements throughout. In the following description, for purposes of explanation, numerous specific details are set forth in order to promote a thorough understanding of one or more aspects of the disclosure. It may be evident in some or all instances, however, that any aspects described below can be practiced without adopting the specific design details described below.

Aspects of the disclosure include a vehicle airbag cover for housing an airbag and an airbag housing member fitted within a steering wheel of a car, wherein the airbag cover includes a plurality of perforations configured to enable the airbag cover to tear open upon deployment of the airbag.

In one example implementation, which should not be construed as limiting, the vehicle airbag cover may include a cover member, wherein the cover member is configured to cover or house an airbag located within a steering wheel and the airbag container or airbag housing member configured to keep the airbag compressed prior to deploying. The cover member further includes a tear seam configured to tear in a one or more locations, based on a perforation pattern, upon deployment of the airbag to allow the airbag to fully deploy and so as to not injure the vehicle occupant.

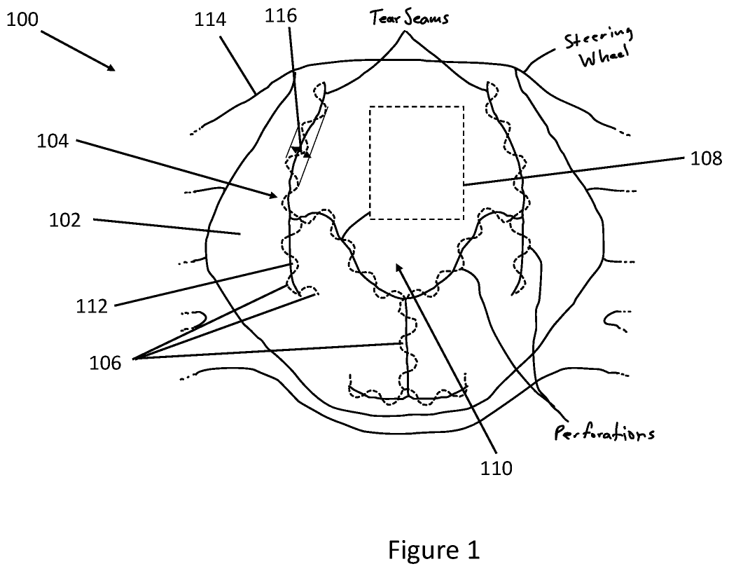

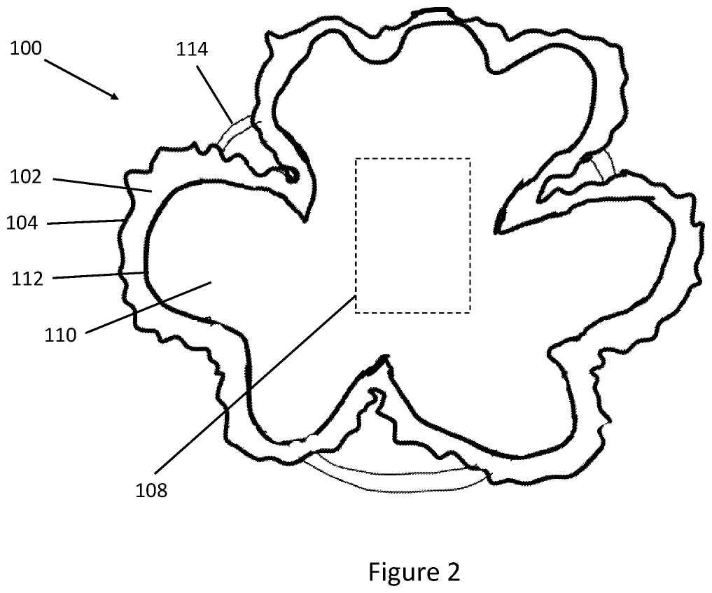

Referring specifically to FIGS. 1 and 2, in one example implementation that should not be construed as limiting, the vehicle airbag cover 100 includes a cover member 102, which is located within, or which partially comprises, a steering wheel 114. The cover member 102 is configured to include at least one cover member tear seam 104 defined by a plurality of perforations 106. The cover member 102 is further configured to break or tear open along the cover member tear seam 104 upon deployment (e.g., inflation) of the airbag 108, which is housed within an airbag housing member 110.

Upon predetermined conditions, for example, detection of a crash, the airbag 108 is configured to rapidly inflate and deploy out of the airbag housing member 110, and in turn out of the steering wheel 114, which is at least partially comprised of the cover member 102. Upon deployment of the airbag 108, the airbag housing member 110 is forced open along at least one airbag housing member tear seam 112. In other words, upon forcible impact to a vehicle, the airbag 108 will deploy, which will break open the airbag housing member 110 along the at least one airbag housing member tear seam 112, and which will then tear open the cover member 102 along the at least one cover member tear seam 104.

As can be seen in FIG. 1, the cover member tear seam 104 is positioned substantially on top of, or aligned with, the airbag housing member tear seam 112. In an aspect, the cover member tear seam 104 is configured to be in a pattern having a width 116, e.g., transverse to a length, that is wider than the airbag housing member tear seam 112. For example, the cover member tear seam 104 may be configured to periodically and/or continuously overlie and/or cross over the airbag housing member tear seam 112. This continuous crossing of the cover member tear seam 104 over the airbag housing member tear seam 112 ensures that the cover member 102 is able to tear open even if it is not precisely positioned on top of the airbag housing member tear seam 112. For instance, the cover member tear seam 104 may have a repeating pattern, as discussed below, to cross back and forth over the airbag housing member tear seam 112 to allow for minor misalignments between the two tear seams. Therefore, if there is an initial misalignment, or over time if either the cover member 102 shifts slightly or the airbag housing member 110 shifts slightly, the cover member tear seam 104 will still be positioned over the airbag housing member tear seam 112 such that the airbag 108 can safely and effectively deploy.

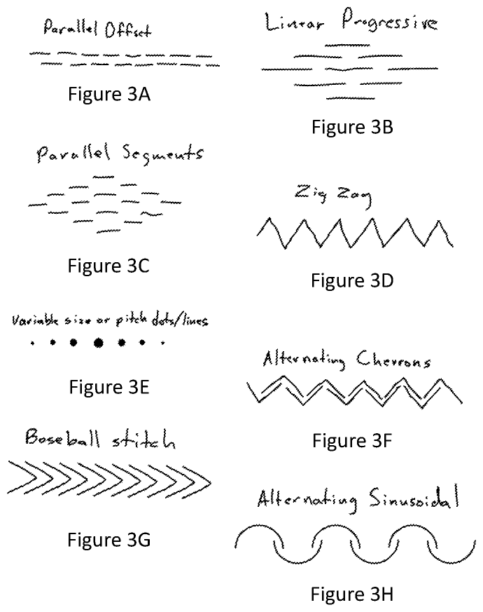

Specifically referring to FIGS. 3A-3H the cover member tear seam 104 may include a variety of different tear seam patterns and the plurality of perforations 106 may be a variety of different sizes and shapes. For instance, the pattern of the plurality of perforations 106 may be a parallel offset pattern 302 (FIG. 3A), a linear progressive pattern 304 (FIG. 3B), a parallel segments pattern (FIG. 3C), a zig zag pattern (FIG. 3D), a variable size or pitch pattern (FIG. 3E), an alternating chevrons pattern (FIG. 3F), a baseball stitch pattern (FIG. 3G), or an alternating sinusoidal pattern (FIG. 3H) among other patterns. For example, instead of the cover member tear seam 104 continuously crossing over the airbag housing member tear seam 112, as shown in FIG. 1, the pattern of the cover member tear seam 104 may include a pattern similar to that of 3A-3C and 3G, which include parallel perforation patterns, wherein the pattern of the cover member tear seam 104 has a width substantially larger than that of the airbag housing member tear seam 112. As such, if either the cover member 102 or the airbag housing member 110 shifts slightly, the cover member tear seam 104 will still be positioned over the airbag housing member tear seam 112. Additionally, when the cover member tear seam 104 does include a pattern which continuously crosses over the airbag housing member tear seam 112, as shown in FIG. 1, numerous different patterns may be used. For example the patterns may include patterns similar to those shown in FIGS. 3D, 3F and 3H, such as a sinusoidal wave, a saw-tooth wave, a triangle wave, or a square wave, which each will periodically or continuously cross over the airbag housing member tear seam 112. For example, looking at the left side of the airbag housing member tear seam 112 of FIG. 1, the corresponding cover member tear seam 104 crosses over the airbag housing member tear seam 112 from side to side and similarly crosses over each other section of the airbag housing member tear seam 112. These patterns described above are merely examples of perforation patterns which may be used, and should not be construed as limiting, as a multitude of similar pattern types may be used.

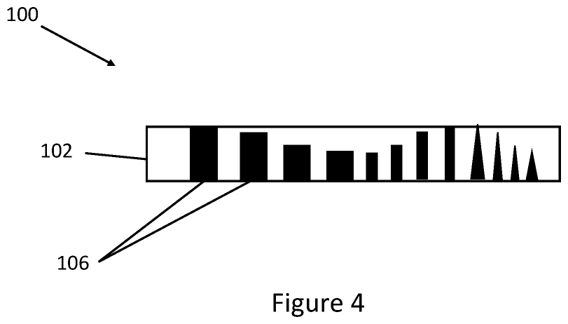

While the perforations may be consistent and/or relatively similar, in a further aspect as shown in FIG. 3E as well as in FIG. 4, each perforation of the plurality of perforations 106, may be variable. For example, a pattern may utilize wider and/or longer perforations, and may therefore not need as many perforations to cover the housing tear seam 112. Alternatively, each perforation may be very small and narrow and there may then be a greater number of perforations within the pattern. This is particularly useful as different vehicles, which incorporate different stylistic constraints, may require different perforation patterns and different individual perforations 106.

Referring to FIG. 4, in a first example aspect, for a luxury or high end vehicle, visual aesthetics may be an important factor in designing a steering wheel cover. In this example aspect, the plurality of perforations 106, which may be made into the underside of the cover member 104, may not fully penetrate the cover member 104, and would therefore not be visible at all on the outside of the cover member to the operator of the vehicle. This example aspect would require smaller perforations 106, and therefore an increased number of perforations 106, which may be located closer together.

As further shown in FIG. 4, in a second alternative example aspect, for a non-high end vehicle, visual aesthetics may be less important. In this example aspect, the plurality of perforations 106 may fully penetrate the cover member and would therefore be partially visible on the outside of the cover to the operator of the vehicle. This example aspect may utilize thicker and larger perforations 106 and thus may utilize a smaller number of perforations 106. The airbag cover 102 is highly variable and customizable and may be created to fit any necessary constraints such as for the example aspects described above.

The airbag cover 102 may additionally be created from a variety of different materials. For example, the airbag may be made of a polyester and polyurethane material, such as but not limited to ALCANTARA™ material, or other similar premium textiles. The utilization of Alcantara™ material, or other similar premium textiles, additionally allows for a variety of colors and styles to be chosen during the production of the airbag cover 102. Standard steering wheel covers generally can only be made in a standard black whereas the airbag cover described herein is highly customizable. Further, other materials apart from Alcantara may be used, such as but not limited to leather, cloth, fabric, or foam rubber etc. The combination of each of the elements described above allows for a very safe airbag cover design, which is also highly customizable aesthetically, and may therefore be utilized in a multitude of different applications for a variety of different vehicles.

In general, the description of the aspects disclosed should be considered as being illustrative in all respects and not being restrictive. The scope of the present disclosure is shown by the claims rather than by the above description, and is intended to include meanings equivalent to the claims and all changes in the scope. While preferred aspects of the disclosure have been described above, it is to be understood that variations and modifications will be apparent to those skilled in the art without departing from the scope and spirit of the disclosure.

1. A vehicle airbag cover, comprising:
a cover member configured to house an airbag and an airbag housing member, or a portion of the airbag and the airbag housing member, fitted within a steering wheel of a car; and
a plurality of perforations on the cover member, which comprise a tear seam, and that are configured to allow the cover member to tear open upon deployment of the airbag.

2. The airbag cover of claim 1, wherein a cover material of the cover member comprises polyester and polyurethane.

3. The airbag cover of claim 1, wherein a cover material of the cover member comprises leather, cloth, fabric, or foam rubber.

4. The airbag cover of claim 1, wherein the plurality of perforations partially penetrate through the cover member.

5. The airbag cover of claim 1, wherein the plurality of perforations completely penetrate through the cover member.

6. The airbag cover of claim 1, wherein the plurality of perforations are arranged in a pattern that allows for the airbag cover to tear in a controlled manner.

7. The airbag cover of claim 6, wherein the pattern of the plurality of perforations include a periodic wave pattern.

8. The airbag cover of claim 7, wherein the periodic wave pattern comprises at least one of a sinusoidal wave, a saw-tooth wave, a triangle wave, or a square wave.

9. The airbag cover of claim 6, wherein the pattern of the plurality of perforations has a variable width.

10. The airbag cover of claim 9, wherein the variable width is configured to allow the airbag cover to tear if at least a portion of the plurality of perforations are spaced apart from a tear seam pattern of the airbag housing member.

11. The airbag cover of claim 1, wherein the plurality of perforations are arranged in a pattern that repeatedly crosses a tear seam pattern of the airbag housing member.

12. The airbag cover of claim 1, wherein a plurality of perforations are arranged in a plurality of patterns which each cross over one another and that each repeatedly cross over a tear seam pattern of the airbag housing member.

13. The airbag cover of claim 1, wherein each of the plurality of perforations comprise dots or line segments.
